(19) United States
(12) Patent Application Publication
(10) Pub. No.: US 2018/0055731 A1
(43) Pub. Date: Mar. 1, 2018

(54) Halo ice bag for treating migraine

(71) Applicant: Paulette Bontempo, Blue Bell, PA (US)

(72) Inventor: Paulette Bontempo, Blue Bell, PA (US)

(21) Appl. No.: 15/804,091

(22) Filed: Nov. 6, 2017

Related U.S. Application Data
(62) Division of application No. 13/896,908, filed on May 17, 2013.
(60) Provisional application No. 61/650,552, filed on May 23, 2012.

(51) Int. Cl. A61H 99/00

(52) U.S. Cl. CPC A61H 99/00

(57) ABSTRACT

A halo ice bag comprises a plurality of selectably sealable compartments. The selectably sealable compartments are joined one to another by an elastic and define a first end and a second end of the halo ice bag. A selectable closure can join the first end to the second end to define a closed loop. The elastic allows the halo ice bag to conform to the head of a wearer. An insulating layer and comfort layer prevent excess heat loss from the wearer's head and render the halo ice bag dry to the touch. The comfort layer may include a superabsorbent polymer or hydrogel.

### PRIORITY

This application is a divisional application of U.S. application Ser. No. 13/896,908 filed on May 17, 2013, claiming priority of U.S. provisional application 61/650,552 filed on May 23, 2012 the contents of both of which are incorporated herein by reference.

### I. BACKGROUND OF THE INVENTION

A. Field of the Invention

The invention is an apparatus and method for cooling the head of a user. The apparatus is an ice bag, particularly an ice bag that conforms to the shape of the head of the user. The user may be a migraine sufferer and the apparatus may be used to alleviate the symptoms of a migraine headache. The apparatus also may be used to alleviate a fever. The method of the invention is a method of using the halo ice bag.

B. Statement of the Related Art

Bags that utilize water ice to cool the head of a person are known. Cooling of the head of a migraine headache sufferer is known to reduce the symptoms of a migraine headache, as taught by U.S. Pat. No. 2,796,903 to Gazelle, issued Aug. 19, 1954.

Ice bags or cold packs that can be held against the body of a person are known in the art. See U.S. Patent Publication 2005/0222654 by Brown published Oct. 6, 2005; U.S. Pat. No. 4,204,543 to Henderson issued May 17, 1980; U.S. Pat. No. 5,628,772 to Russell issued May 13, 1997; U.S. Pat. No. 5,395,400 to Stafford issued Mar. 7, 1995; U.S. Pat. No. 4,854,319 to Tobin issued Aug. 8, 1989; U.S. Pat. No. 1,569,877 to Owens issued Jan. 19, 1926; U.S. Pat. No. 702,759 to Allegretti, issued Jun. 17, 1902; U.S. Pat. No. 4,614,189 to MacKenzie issued Sep. 30, 1986; and U.S. Pat. No. 4,372,318 to Vicsturs issued Feb. 8, 1983.

The prior art ice bags and cold packs do not allow the user to select what portions of the user's head will be cooled, up to the entire circumference of the head, when the user does not have access to a freezer but does have access to ice, as when the user is travelling. The prior art apparatus for cooling the head of a user also are not convenient to carry by a traveler or to dispense from a conventional vending machine.

### II. BRIEF DESCRIPTION OF THE INVENTION

The invention is a specialized ice bag to provide relief from head pain, especially for migraine headache sufferers. The ice bag is configured in a halo, or head-band shape, and is sized so that the halo can be extended around the forehead, over the ears, and around the back of the head of the wearer.

The ice bag includes three or more openable and re-sealable water-tight compartments extending around the circumference of the halo ice bag. Each of the water-tight compartments is defined by a water-impermeable liner, as by a liner composed of low density polyethylene. Any other suitable impermeable material may be selected for the liner. The liner of each water-tight compartment has a top side that defines two opposing edges of the plastic liner. The two opposing edges can be selectably opened and re-sealed in a watertight manner using a water-tight closure. The water-tight closure may be a closure integral to the liner commonly known as a seal-top, zipper, or re-sealable closure, which may or may not have a slider to assist in closure. The closure features a groove molded into one edge of the liner and a track molded into the opposing edge. The two edges are sealed when the track and groove are pressed together.

Each of the water-tight compartments opens from the top side of the halo ice bag. The top side is the portion of the compartment that is uppermost when the halo ice bag is in place on the head of a user and the user is standing or sitting upright. The top side opening reduces the likelihood of leakage of water from the compartment when the halo ice bag is worn on the head.

The three or more compartments extend around the circumference of the halo ice bag, with one compartment attached to the next. The multiple water-tight compartments are openable and re-sealable to allow the halo ice bag to be charged with water ice from any convenient source, to be sealed and to be placed on the head. Separate and independent compartments allow the user to charge with ice only the compartments needed for targeted relief while leaving other areas of the user's head free from cold.

Elastic material attaches each compartment to the next compartment, which allows the halo ice bag to stretch to conform to the head of the user for increased comfort and for a more versatile fit than would otherwise be possible. Two of the compartments may not be attached together and instead a releasable closure is provided, such as mating pieces of hook-and-loop fastener, to allow the two compartments to be selectably attached together. A familiar trademark for one brand of hook-and loop fastener is Velcro®. The use of the hook-and-loop fastener allows the halo ice bag to be selectably fitted by a user regardless of the size or shape of the user's head. When the two compartments arc not attached, the halo ice bag is not ring-shaped and may be stored flat or folded. The folded halo ice bag may be contained within a compact package or box. The halo ice bag may be purchased or dispensed through a conventional vending machine, drug store or medical center.

Each compartment has an inward side and an outward side. The inward side will contact the skin of the user when the halo ice bag is in use. The outward side will not contact the skin of the user when the halo ice bag is in use. The halo ice bag features two thermally insulating layers, with one thermally insulating layer disposed on the inward side of the liner and the other disposed on the outward side of the liner. The halo ice bag also features two comfort layers, with one comfort layer disposed on the inward side of the halo ice bag adjacent to the thermally insulating layer and the other disposed on the outward side of the halo ice bag adjacent to the thermally insulating layer. On the inward side of the halo ice bag, the comfort layer contacts the skin of the user. On the outward side of the compartment, the comfort layer is exposed and does not contact the skin of the user.

The thermally insulating layer may be any suitable thickness of a suitable thermal insulating material that allows contact between the skin of the user and the halo ice bag. The insulating layer is selected to allow adequate cooling of the user's head without causing excessive chilling of the skin of the user that could damage the skin. The insulating layer also serves to prevent rapid melting of the ice within the ice bag due to high ambient temperatures or for any other reason. Open-cell foam has proven suitable as the thermally insulating layer in practice, but any suitable thermal insulator may be used. Examples of thermal insulators that may be suitable are fabric felt, polyester or other batting, glass fibers, woven or non-woven fabrics composed of either synthetic or natural materials, ceramic materials, glass materials, metallic materials or any suitable thermal insulator known in the art.

The purpose of the comfort layers is to prevent liquid water from reaching the skin of the user and also to wick away any liquid water that does reach the user's skin. The comfort layers also ensure that the halo ice bag is dry to the touch and does not wet clothing, business papers, computers or the like.

The two comfort layers each has a composition similar to that of a disposable diaper; namely, an absorbent pad disposed between two layers of a non-woven fabric. The absorbent pad may be a composed of a hydrogel or superabsorbent polymer, as are known in the art. The hydrogel or superabsorbent polymer may he mixed with a fibrous material, such as wood pulp, to conduct water to the hydrogel or superabsorbent polymer molecules for absorption. The layers of non-woven fabric support and protect the absorbent pad. The layer of non-woven fabric on the inward surface of the halo ice bag is permeable, to allow water from the user's skin to be transmitted to the absorbent pad. The layer of non-woven fabric on the outward surface of the halo ice bag may be selected to be permeable or non-permeable. If the outward surface is selected to be permeable, then the halo ice bag is dry to the touch. If the outward surface is selected to be impermeable, then the impermeable outward surface prevents escape of water from the absorbent pad. Any other composition for the comfort layers known in the art is contemplated by the invention.

The comfort layer and the insulation layer may be one and the same. An absorbent fabric, such as cotton terrycloth I 1bric, may be selected as the insulation layer, the comfort layer, or the combination insulation and comfort layer.

The halo ice bag may feature one or more straps extending from the top side of the halo ice bag at a first location over the crown of the user's head to the top side of the halo ice bag at a second location opposing the first location on the other side of the user's head. The one or more straps prevents the halo ice bag from slipping due to gravity when the user is standing or is sitting in an upright position. For example, the one or more straps will prevent the halo ice bag from slipping from the forehead and over the eyes of the user.

In the method of the invention, a user may select an area of the patient's head to cool and may select compartments corresponding to the area to be cooled. The user may open the selected compartments using the selectably sealable openings and may charge the opened compartments with water ice or with a mixture of water and ice. The user will re-seal the selected compartments. The user will place the halo ice bag in contact with the user's head and will conform the halo ice bag to the user's head by applying tension to the ends of the halo ice bag, thereby stretching the resilient elastic material and hence the halo ice bag about the user's head. The user will attach the first end to the second end using the selectable closure, retaining the halo ice bag to the user's head. The user optionally may attach one or more straps over the crown of the user's head to hold the halo ice bag in place.

### III. BRIEF DESCRIPTION OF THE FIGURES

FIG. 1 is a perspective view of a first embodiment.

FIG. 2 is a plan view of the first embodiment with ends not attached.

FIG. 3 is a perspective view of a second embodiment.

FIG. 4 is a plan view of the second embodiment with ends unattached.

FIG. 5 is a first perspective view of the first embodiment in use.

FIG. 6 is a second perspective view of the first embodiment in use.

FIG. 7 is a third perspective view of the first embodiment in use.

FIG. 8 is a cross section of a compartment in the closed position.

FIG. 9 is a detail cross section of a portion of FIG. 8.

FIG. 10 is a cross section of a compartment in the open position.

FIG. 11 is a cross section of an alternative compartment in the closed position.

FIG. 12 is a perspective view of the first embodiment including a strap.

FIG. 13 is a perspective view of the apparatus packaged for sale.

FIG. 14 is a flow chart of a method for use of the apparatus.

### IV. DESCRIPTION OF AN EMBODIMENT

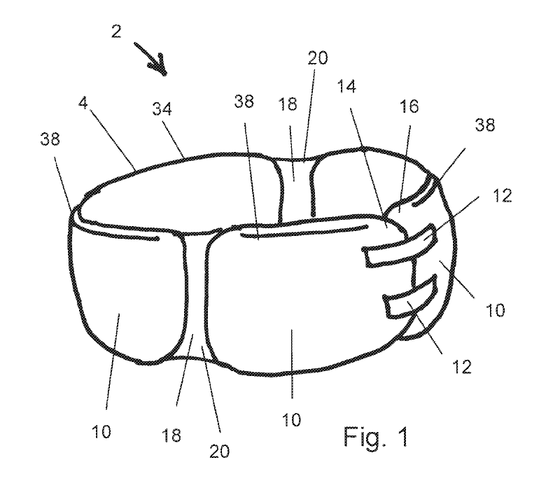

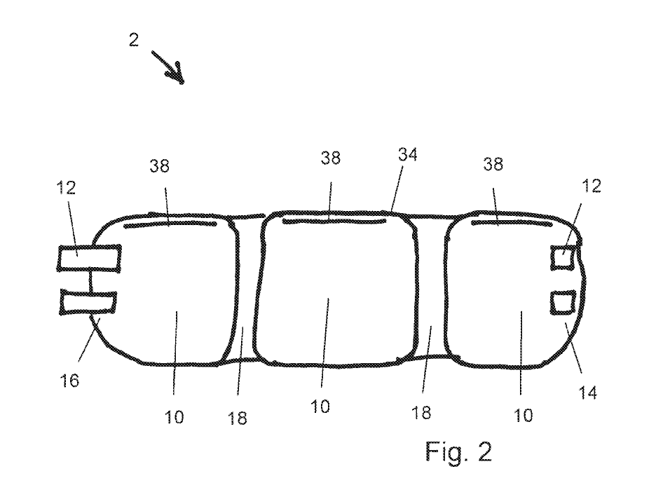

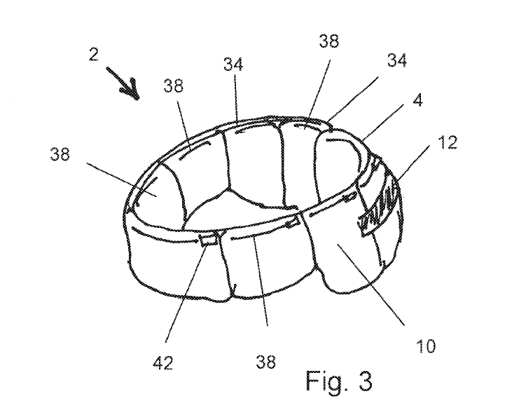

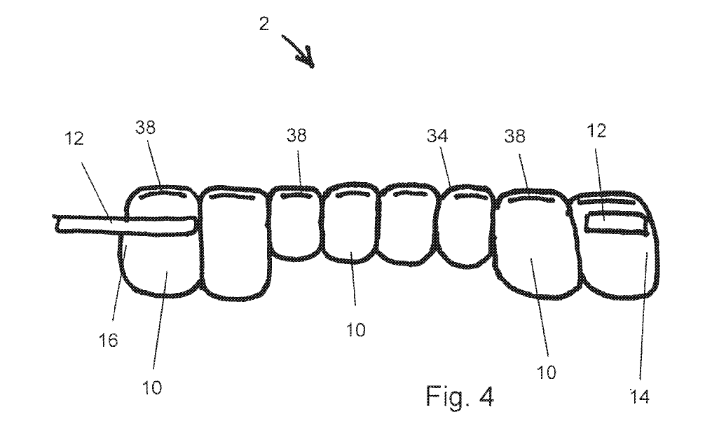

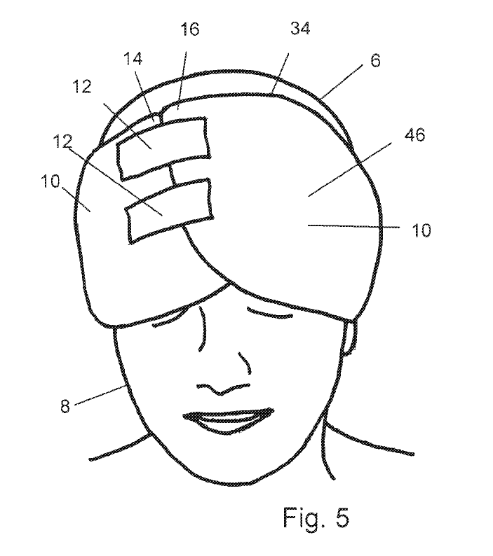

FIGS. 1 and 2 show a first embodiment of the apparatus of the invention and FIGS. 3 and 4 show a second embodiment. The apparatus is a halo ice bag 2. The halo ice bag 2 has an assembled position, shown by FIGS. 1 and 3, and a stored position, shown by FIGS. 2 and 4. In the assembled position, the halo ice bag 2 forms a closed loop 4, has a circumference, and is shaped to conform to the head 6 of the user 8, as shown by FIG. 5. In the stored position of FIGS. 2 and 4, the halo ice bag 2 does not define a closed loop 4 and does not have a circumference. In the stored position, the halo ice bag 2 may be readily stored or transported, as by a business traveler.

When assembled, the halo ice bag 2 is configured to encircle the head 6 of a user 8 and extending from the forehead, over the temples of the user 8, above the ears of the user 8 and around the back of the user's head 6. The halo ice bag 2 features at least three water-tight compartments 10, as shown by the first embodiment illustrated by FIGS. 1 and 2. The second embodiment shown by FIGS. 3 and 4 includes eight water-tight compartments 10. Any desired number of water-tight compartments 10 may be used for the halo ice bag 2 and any number of water-tight compartments 10 are contemplated by the invention.

As shown by FIGS. 1-5 and 10, a selectable closure 12, which may be mating hook-and-loop fasteners, allows the user 8 to releasably fix the first end 14 and the second end 16 of the halo ice bag 2 one to the other to select the assembled position of FIGS. 1 and 3. The hook-and-loop fasteners also allow the user 8 to return the halo ice bag 2 to the stored position shown by FIGS. 2 and 4 by separating the first and second ends 14, 16. Any other means known in the art to allow the ends 14, 16 to be releasably attached one to the other is contemplated by the invention, including a snap, button, tie, spring, loop, magnetic fastener, zipper, or any other suitable selectable closure 12 known in the art. The first and second ends 14, 16 preferably define the portion of the halo ice bag 2 that will contact the face and forehead of the user 8, so that the selectable closure 12 is located in front of the user 8 when worn. The frontal location allows convenient attachment and detachment of the ends 14, 16 while the halo ice bag 2 is in position on the user's head 6.

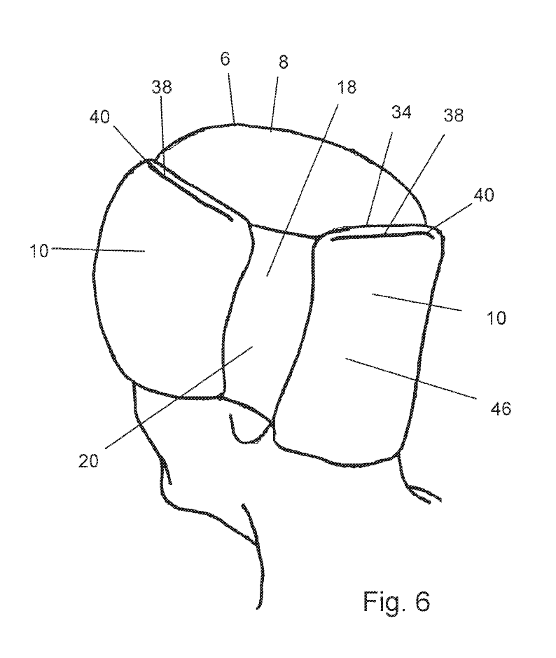

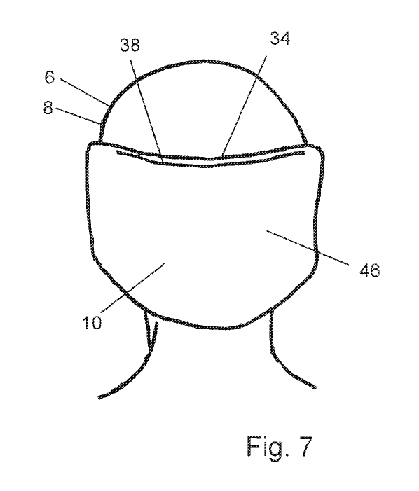

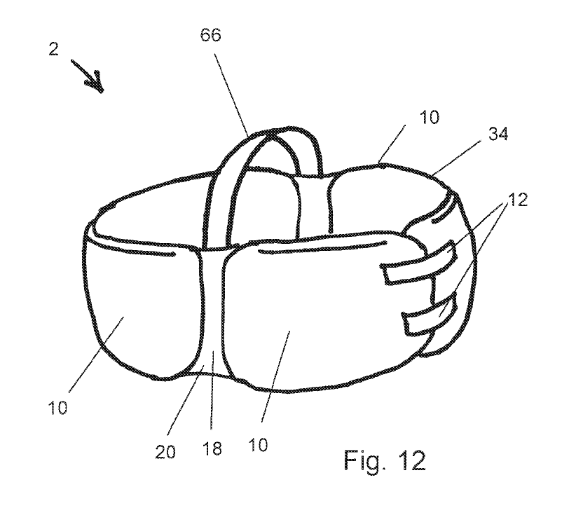

As shown by FIGS. 1, 2, 6 and 12, the water-tight compartments 10 are attached one to the next by a plurality of attachments 18 composed of an elastic 20, which may be an elastic fabric that incorporates resilient thread. The elastic 20 allows the halo ice bag 2 to deform elastically in tension between the first and second ends 14, 16 and allows each compartment 10 to move resiliently with respect to the compartments 10 to which it is attached. The relative resilient movements of the compartments 10 provided by the elastic 20 allows the halo ice bag 2 to conform to the head 6 of the user 8, as shown by FIGS. 5, 6 and 7. The elastic 20 also serves to hold the adjoining water-tight compartments 10 in position with respect to each other. While the elastic 20 may comprise a single band of elastic fabric extending from the first end 14 to the second end 16, preferably a plurality of portions of the elastic 20 each extends from one compartment 10 to an adjacent compartment 10, as illustrated by FIGS. 1 and 12.

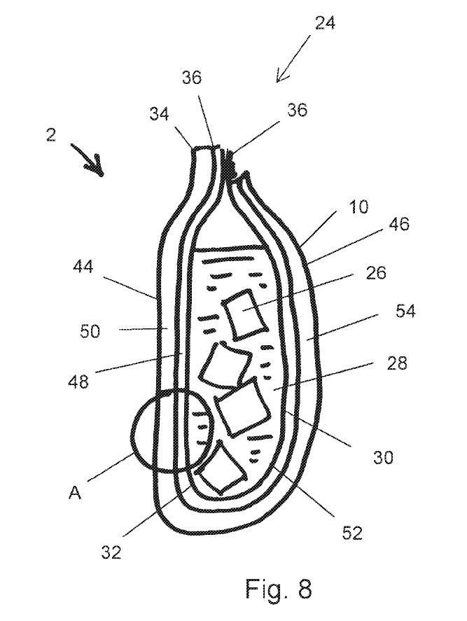

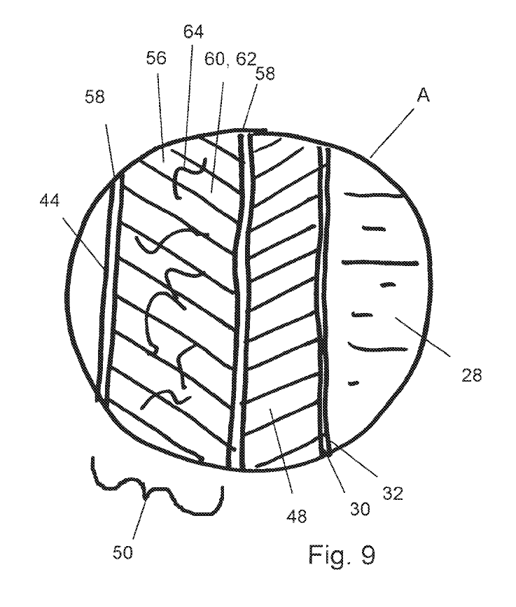

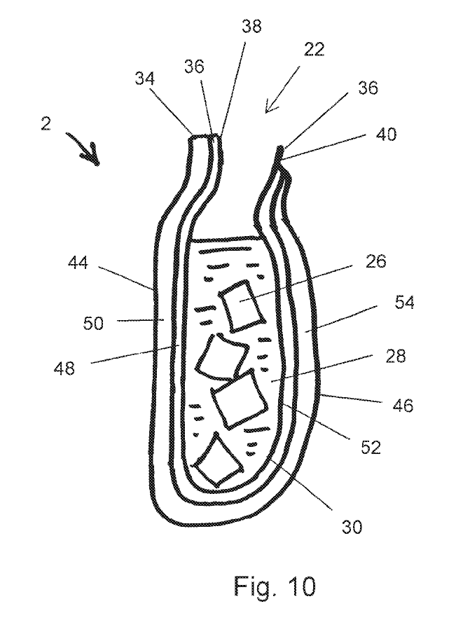

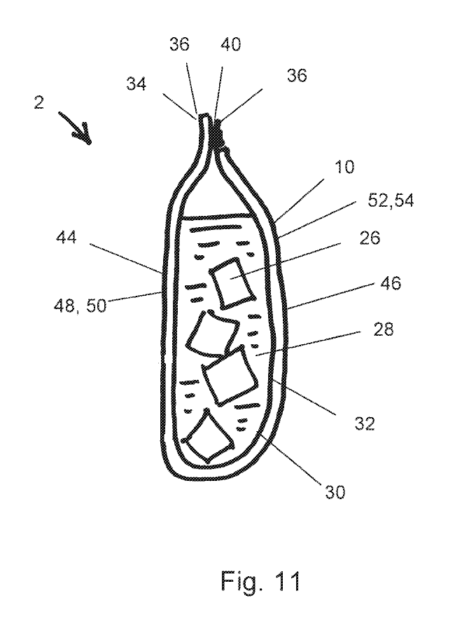

FIGS. 8 through 11 illustrate the construction of each water-tight compartment 10. FIG. 8 is a cross section of a water-tight compartment 10 in use in a closed position 24. FIG. 9 is detail ‘A’ of FIG. 5. FIG. 10 is a cross section of the water-tight compartment 10 in an open position 22. FIG. 11 is a cross section of an alternate embodiment water-tight compartment 10.

From FIG. 8, water-tight compartment 10 contains water ice 26 and water 28. Ice 26 and water 28 are contained by liner 30. Liner 30 may be composed of any suitable water-impermeable polymer 32. Liner 30 is water-tight and is openable to an open position 22, shown by FIG. 10, and closable to a closed position 24, shown by FIG. 8. In the open position 22, water 28 may be removed from compartment 10 and compartment 10 may be charged with ice 26. In the closed position 24, the compartment is in a sealed condition to contain the ice 26 and water 28. Each water-tight compartment 10 has a top side 34, which is oriented upward when the user 8 is wearing the halo ice bag 2 and is standing or sitting upright. The liner 30 proximal to the top side 34 of the water-tight compartment 10 defines two opposing edges 36, which in combination define a selectably sealable opening 38 to the interior of the compartment 10. The selectably sealable opening 38 is located at the top side 34 of the halo ice bag 2 to reduce potential leakage of water 28 when the user 8 is wearing the halo ice bag 2.

The selectably sealable opening 38 may be sealed by joining the opposing edges 36 with any sealing mechanism 40 known in the art, which may include interlocking strips. An example of sealing mechanisms 40 using interlocking strips are shown by U.S. Pat. No. 3,038,225 to Ausnit issued Jun. 12, 1962. See also U.S. Pat. No. 5,689,866 to Kasai issued Nov. 25, 1997 and U.S. Pat. No. 5,283,932 to Richardson issued Feb. 8, 1994, all of which are incorporated by reference as if set forth in full herein. The sealing mechanism 40 may be equipped with a slider 42 to assist in opening and closing of the selectably sealable opening 38, as shown by FIG. 3.

The halo ice bag 2 has an inward side 44 that is oriented toward the skin of the user 8's head 6 when the halo ice bag 2 is in use and an outward side 46 that is oriented away from the user's skin when the halo ice bag 2 is in use. On the inward side 44 of the liner 30 is an inward side insulating layer 48. The inward side insulating layer 48 is disposed between the sealed compartment 10 and the skin of the user's head 6 and prevents over-rapid transfer of heat to the ice 26 and water 28 from the user's head 6, preserving the ice 26 and preventing damage to the skin of the user 8. Any suitable inward side insulating layer 48 may be used. Open cell foam has proven suitable in practice for inward side insulating layer 48. As an alternative, a cotton terrycloth fabric may be used for the inward side insulating layer 48.

A first comfort layer 50 is disposed on the inward side 44 of the inward side insulating layer 48. The purpose of the first comfot1layer 50 is to absorb water 28 that may leak from the compartment 10 and to prevent the water 28 from reaching the user's skin or the user's clothing or possessions, as when the halo ice bag 2 is stored in the luggage of a business traveler. The first comfort layer 50 is configured to absorb moisture and wicks water 28 away from the user's skin. The first comfort layer 50 causes the inward side 44 of the halo ice bag 2 to feel dry to the touch.

An outward side insulating layer 52 and a second comfort layer 54 may be disposed on the outward side 46 of the halo ice bag 2 and may function in the same manner as the inward side insulating layer 48 and the first comfort layer 50. The outward side insulating layer 52 reduces condensation on the outward side 46 of the halo ice bag 2. The second comfort layer 54 renders the outward side 46 of the halo ice bag 2 dry to the touch.

The construction of the comfort layers 50, 54 is similar to that of a disposable diaper and is illustrated by the detail of FIG. 9. The comfort layer 50, 54 comprises an absorbent pad 56 between first and second layers of non-woven fabric 58. The two layers of non-woven fabric 58 provide structural support for the absorbent pad 56. The absorbent pad 56 is composed of a hydrogel 60 or superabsorbent polymer 62 mixed with fibrous wood pulp 64. Examples of superabsorbent polymers 58 believed to be suitable include sodium polyacrylate, polyacrylamide copolymer, ethylene maleic anhydride copolymer, cross-linked carboxymethylcellulose, polyvinyl alcohol copolymers, cross-lined polyethylene oxide, and starch grafted copolymer of polyacrylonitrile. The fibrous wood pulp 64 transmits moisture to the superabsorbent polymer 62 or hydrogel 60.

The two layers of non-woven fabric 58 are preferably permeable to water 28 where the layers 58 are located on the inward side 44 of the halo ice bag 2. The non-woven fabric layer 58 located on the surface of the outward side 46 may be selected to be permeable or impermeable to water 28. When the non-woven fabric layer 58 on the outward side 46 is selected to be permeable, the outward side 46 is dry to the touch. When the non-woven fabric layer 58 on the outward side 46 is selected to be impermeable, water 28 is prevented from escaping through the outward side 46.

As shown by FIG. 11, the comfort layers 50, 54 may provide adequate thermal insulation to the halo ice bag 2, allowing the insulating layers 48, 52 to be omitted, so that the comfort layers 50, 54 serve also as the insulating layers 48, 52. The comfort layers 50, 54 and the insulating layers 48, 52 may utilize any suitable material known in the art. For example, cotton terrycloth fabric is believed to be suitable for the insulating and comfort layers 48, 52, 50, 54.

As shown by FIG. 12, the halo ice bag 2 may be equipped with a strap 66 that passes from the top side 34 of the halo ice bag 2 and over the top of the user's head 6 to the opposing side of the halo ice bag 2. The strap 66 assists in holding the halo ice bag 2 in place on the user's head 6. The strap 66 may be composed of any suitable material and may attach to the opposing side by hook-and-loop fasteners or by any other suitable means, including snaps, buttons, ties, magnetic fasteners, or by any other suitable attachment apparatus known in the art.

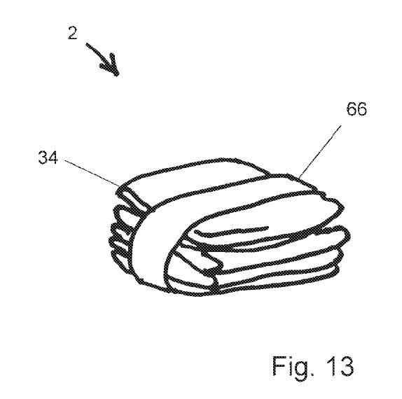

As shown by FIG. 13, the halo ice bag 2 may be compactly packaged for sale or storage. The halo ice bag 2 may be dispensed in any manner known in the art, including by a retail store such as a pharmacy, by a provider or medical services or by a conventional vending machine. The halo ice bag 2 when not charged with ice 26 and water 28, may be folded or rolled to take up little space. In the example embodiment of FIG. 13, the strap 66 is used to retain the halo ice bag 2 in the compact condition. Any other suitable packaging known in the art is contemplated by the invention.

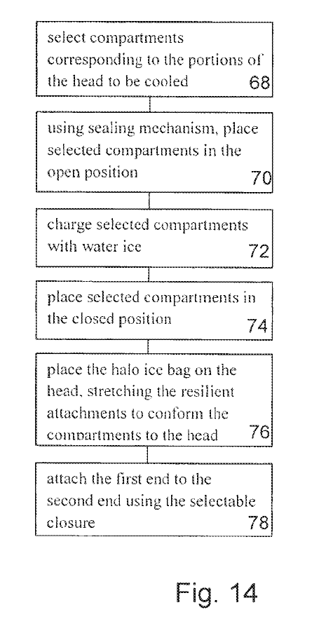

The method of the invention is illustrated by FIG. 14. From step 68, a user 8 may selectively cool one or more areas of the user's head 6 by selecting one or more of the water-tight compartments 10 of the halo ice bag 2. From step 70, the user 8 will place the selected compartments 10 corresponding to the portions of the user's head 6 to be cooled in the open position 22 using the sealing mechanism 40 of each selected compartment 10. From step 72, the user 8 will charge each of the selected compartments 10 with ice 26 through the selectably sealable opening 38. From step 74, the user 8 will place each of the compartments in the closed position 24 by sealing each selectably sealable opening 38 using the sealing mechanism 40. From step 76, the user 8 will place the halo ice bag 2 in position on the user's head 6. The plurality of attachments 18 resiliently stretch, conforming the compartments 10 to the head 6 of the user 8. From step 78, the user 8 will connect the first and second ends 14, 16 one to the other using the selectable closure 12, such as hook-and-loop fasteners. The user 8 may secure strap 66 to the halo ice bag 2 and over the top of the user's head 6 to prevent the halo ice bag 2 from moving on the user's head 6. Heat is transferred from the user's head 6 through the first comfort layer 50 and through the inward side insulating layer 48 to the liner 30 and to the melting ice 26 and chilled water 28, cooling the user's head 6. The inward side insulating layer 48 and first comfort layer 50 slow the transfer of heat adequately so that the user's skin is not excessively chilled, avoiding damage to the user's skin. When the cooling of the user's head 6 is complete, the user 8 may remove the strap 66, separate the first and second ends 14, 16 and open the selectably sealable openings 38 for each of the selected compartments 10. The user 8 then may remove the ice 26 and water 28 from the halo ice bag 2. The halo ice bag 2 is then ready for storage and transport.

The following is a list of numbered elements from the claims, specification and drawings:
halo ice bag 2
closed loop 4
head 6
user 8
plurality of compartments 10
selectable closure 12
first end 14
second end 16
plurality of attachments 18
elastic 20
open position 22
closed position 24
ice 26
water 28
liner 30
water-impermeable polymer 32
top side 34
opposing edges 36
selectably sealable opening 38
sealing mechanism 40
slider 42
inward side 44
outward side 46
inward side insulating layer 48
first comfort layer 50
outward side insulating layer 52
second comfort layer 54
absorbent pad 56
first and a second layer of a non-woven fabric
58 hydrogel 60
superabsorbent polymer 62
fibrous wood pulp 64
strap 66

What is claimed is:

1. A cryotherapy device comprising:
a. a plurality of compartments, each compartment having an inward side, an outward side and a top side, the top side defining a selectably sealable opening having an open position and a closed position, each compartment being configured to selectably and independently receive ice or ice water when the opening is in the open position, and each compartment being configured to separately and independently retain ice or ice water when said sealable opening is in the closed position;
b. a plurality of attachments, each of the attachments connecting at least one compartment to another compartment, such that the compartments are arranged to form a linear configuration having a first and a second end compartment and at least one middle compartment; and
c. a selectable closure to selectably attach the first end compartment to the second end compartment to form a closed compartment loop.

2. The device of claim 1, wherein the attachments are elastic allowing movement of the compartments in relation to each other when tension is applied to the first and to the second ends.

3. The device of claim 1, wherein each compartment is defined by a liner composed of a water-impermeable polymer.

4. The device of claim 3, wherein each compartment has an inward side insulating layer on the inward side of the compartment configured to prevent damage to the skin due to rapid transfer of heat from the skin to the ice.

5. The device of claim 4, the apparatus further comprising a first comfort layer disposed on an outer surface of the inward side.

6. The device of claim 5, wherein the first comfort layer is composed of a first and a second layer of a non-woven fabric and a hydrogel or a superabsorbent polymer between the first and the second layer.

7. The device of claim 6, wherein said first comfort layer and said inward side insulating layer are one and same.

8. The device of claim 4, wherein each compartment has an outward side insulating layer configured to reduce a condensation of moisture on the outward side.

9. The device of claim 8 further comprising a second comfort layer, being disposed on top of the outward side, said comport layer being composed of a first and a second layer of water permeable non-woven fabric and having a hydrogel or superabsorbent polymer in between of the first and the second layers.

10. The device of claim 9, wherein said second comfort layer and said outward side insulating layer are one and the same.

11. The device of claim 1, wherein the device is disposable.

12. A migraine treatment device comprising a multitude of linearly arranged compartments selectably and independently fillable with ice or ice water, wherein the device has two end compartments and at least one middle compartment,
each end compartment being attached to one middle compartment by elastic connecting attachments and the end compartments having selectable closures capable of connecting the end compartments together to arrange the device into a compartment loop adapted to encircle a patient's head;
each compartment having a top side configures to face upward when the device encircles the head, an inward side configures to face patient's head and an outward side to face outward,
the top side defining a selectably sealable opening having an open position and a closed position, and each of the compartments configured to receive ice or ice water when the opening is in open position, and each of said compartments being configured to retain the ice or ice water when the sealable opening is in closed position;
each compartment having a multilayer structure, wherein an innermost layer is a water-impermeable liner;
at least the inward side of each compartment comprising an insulation layer next to the water-impermeable liner and a first comfort layer next to the insulation layer, wherein the first comfort layer is configured to engage skin of a user when the compartment loop is arranged around the user's head.

13. The device of claim 12, wherein each compartment has a second comfort layer next to the impermeable liner on the outward side.

14. The device of claim 12, wherein the first comfort layer is composed of a first and a second layer of a non-woven fabric and a hydrogel or superabsorbent polymer in between the first and the second non-woven fabric layers.

15. The device of claim 12, wherein the at least one middle compartment has different size than the end compartments.

16. The device of claim 15, wherein the different sized compartments are configured to cover ears or forehead of the user.

17. The device of claim 12, wherein the device is disposable.

18. A single use migraine treatment device for travelers, wherein the device is foldable and comprises a multitude of linearly arranged compartments, each compartment comprising a water impermeable liner and being adapted to be independently and selectably filled with ice or water ice, and wherein at least one of the compartments is attached by an elastic attachment to two other compartments and at least to compartments are attached by an elastic attachment to one other compartment only and defining a first end and a second end of the device, and wherein the first and the second end of the device are attachable to each other to form a loop for encircling a patient's head.

19. The device of claim 18, wherein at least one compartment is larger than the other compartment.

20. The device of claim 19, wherein larger compartments are configured to cover the ears of the patient.
